(19) United States
(12) Patent Application Publication
(10) Pub. No.: US 2017/0235827 A1
(43) Pub. Date: Aug. 17, 2017

(54) VOCALIZING SHORT RESPONSES TO VOICE QUERIES

(71) Applicant: Google Inc., Mountain View, CA (US)

(72) Inventors: Omer BAR-OR, Mountain View, CA (US); Manas TUNGARE, Mountain View, CA (US); Steve CHENG, Los Altos, CA (US); Pravir Kumar GUPTA, Mountain View, CA (US); Phan Dao Minh TRUONG, Santa Clara, CA (US); Bruce R CHRISTENSEN, Mountain View, CA (US)

(21) Appl. No.: 13/922,962

(22) Filed: Jun. 20, 2013

Related U.S. Application Data
(60) Provisional application No. 61/664,396, filed on Jun. 26, 2012.

(51) Int. Cl. G06F 17/30

(52) U.S. Cl. CPC G06F 17/30755

(57) ABSTRACT

A device determines at least one search result that is responsive to a textual representation of a voice query. The at least one search result includes a reference to a first document related to the voice query, a first set of text from a content of the first document, and a second set of text that is responsive to the voice query. The second set of text is in a complete sentence form. The device converts the second set of text into information corresponding to an audible version of the second set of text, and generates a second document that includes the reference to the first document, the first set of text, the second set of text, and the information corresponding to the audible version of the second set of text. The device provides the second document to a client device for presentation on a display.

### RELATED APPLICATION

This application claims priority under 35 U.S.C. §119 based on U.S. Provisional Patent Application No. 61/664,396, filed Jun. 26, 2012, the disclosure of which is incorporated by reference herein in its entirety.

### BACKGROUND

The disclosure relates to technology for providing search results in response to voice input queries. Electronic devices, e.g., computers and mobile communication devices, use a variety of mechanisms to provide input to the devices and to receive output from the devices. Keyboards are common input devices, and they typically include letters of the alphabet, symbols, and numbers. On some mobile devices, keyboards are displayed on a touch screen of the device. Display screens are common output devices.

### SUMMARY

Described herein are devices and techniques for providing search results to a user's voice query. The search results may include several information components responsive to the voice query. One information component may include an answer to the voice query in complete sentence form. Another information component may include an audible version of the answer to the voice query in complete sentence form. Other information components may include a link to a web page relevant to the voice query and text from the web page. The information components of the search results may enable the user to extract information from the search results in more than one way.

In some possible implementations, a method, performed by one or more computer devices, may include: determining at least one search result that is responsive to a textual representation of a voice query, the at least one search result including a reference to a first document related to the voice query, a first set of text from the first document, and a second set of text that is responsive to the voice query, the second set of text being in a complete sentence form; converting the second set of text into information corresponding to an audible version of the second set of text; generating a second document that includes the reference to the first document, the first set of text, the second set of text, and the information corresponding to the audible version of the second set of text; and providing the second document to a client device.

In some possible implementations, the method may further include: receiving the voice query from the client device; and converting the voice query into the textual representation of the voice query.

In some possible implementations, the method may further include receiving the textual representation of the voice query from the client device.

In some possible implementations, the method may further include: generating a representation of the information corresponding to the audible version of the second set of text; and providing the representation in the second document, the audible version of the second set of text being an executable file that is executed when the representation is selected via the client device.

In some possible implementations, the second set of text may be derived from the first document.

In some possible implementations, the audible version of the second set of text may be an executable file that is automatically executed by the client device when the second document is received by the client device.

In some possible implementations, a device may include one or more processors to: determine at least one search result that is responsive to a textual representation of a voice query, the at least one search result including a reference to a first document related to the voice query, a first set of text from a content of the first document, and a second set of text that is responsive to the voice query, the second set of text being in a complete sentence form; convert the second set of text into information corresponding to an audible version of the second set of text; generate a second document that includes the reference to the first document, the first set of text, the second set of text, and the information corresponding to the audible version of the second set of text; and provide the second document to a client device for presentation on a display.

In some possible implementations, the one or more processors may be further to: receive the voice query from the client device, convert the voice query into the textual representation of the voice query, and perform a search, based on the textual representation of the voice query, to generate the at least one search result.

In some possible implementations, the one or more processors may be further to: receive the textual representation of the voice query from the client device, and perform a search, based on the textual representation of the voice query, to generate the at least one search result.

In some possible implementations, the one or more processors may be further to: generate a representation of the information corresponding to the audible version of the second set of text, and provide the representation in the second document, the audible version of the second set of text being an executable file that is executed when the representation is selected via the client device.

In some possible implementations, the second set of text may be derived from the first document or from the first set of text.

In some possible implementations, the audible version of the second set of text may be an executable file that is automatically executed by the client device when the second document is received by the client device.

In some possible implementations, a method, performed by a client device, may include: receiving a voice query; converting the voice query into a textual representation of the voice query; providing the textual representation of the voice query to a search system; receiving, from the search system, at least one search result that is responsive to the textual representation of the voice query, the at least one search result including a reference to a document related to the voice query, a first set of text from a content the document, a second set of text that is responsive to the voice query, the second set of text being in a complete sentence form, information corresponding to an audible version of the second set of text, and a representation of the information corresponding to the audible version of the second set of text; and providing, for display, the reference to the document, the first set of text, the second set of text, and the representation of the information corresponding to the audible version of the second set of text.

In some possible implementations, the method may further include: receiving a selection of the representation of the information corresponding to the audible version of the second set of text; and executing the audible version of the second set of text based on the selection.

In some possible implementations, the method may further include executing, automatically, the audible version of the second set of text when the at least one search result is received.

In some possible implementations, the second set of text may be derived from the document or from the first set of text.

In some possible implementations, a device may include one or more processors to: receive a voice query; transform the voice query into a textual representation of the voice query; provide the textual representation of the voice query to a search system; receive, from the search system, at least one search result that is responsive to the textual representation of the voice query, the at least one search result including a reference to a document related to the voice query, a first set of text from a portion of the document, a second set of text that is responsive to the voice query, the second set of text being in a complete sentence form, information corresponding to an audible version of the second set of text, and a representation of the information corresponding to the audible version of the second set of text; and provide, for display, the reference to the document, the first set of text, the second set of text, and the representation of the information corresponding to the audible version of the second set of text.

In some possible implementations, the one or more processors may be further to: receive a selection of the representation of the information corresponding to the audible version of the second set of text; and execute the audible version of the second set of text based on the selection.

In some possible implementations, the one or more processors may be further to execute, automatically, the audible version of the second set of text when the at least one search result is received.

In some possible implementations, the second set of text may be derived from the document or from the first set of text.

In some implementations, a system may include: means for determining at least one search result that is responsive to a textual representation of a voice query, the at least one search result including a reference to a first document related to the voice query, a first set of text from the first document, and a second set of text that is responsive to the voice query, the second set of text being in a complete sentence form; means for converting the second set of text into information corresponding to an audible version of the second set of text; means for generating a second document that includes the reference to the first document, the first set of text, the second set of text, and the information corresponding to the audible version of the second set of text; and means for providing the second document to a client device.

In some implementations, a system may include: means for receiving a voice query; means for converting the voice query into a textual representation of the voice query; means for providing the textual representation of the voice query to a search system; means for receiving, from the search system, at least one search result that is responsive to the textual representation of the voice query, the at least one search result including a reference to a document related to the voice query, a first set of text from a content the document, a second set of text that is responsive to the voice query, the second set of text being in a complete sentence form, information corresponding to an audible version of the second set of text, and a representation of the information corresponding to the audible version of the second set of text; and means for providing, for display, the reference to the document, the first set of text, the second set of text, and the representation of the information corresponding to the audible version of the second set of text.

The above discussion mentions examples in which some implementations may be implemented via one or more methods performed by one or more processors of one or more devices. In some implementations, one or more systems and/or one or more devices may be configured to perform one or more of the acts mentioned above. In some implementations, a computer-readable medium may include computer-executable instructions which, when executed by one or more processors, cause the one or more processors to perform one or more of the acts mentioned above.

### BRIEF DESCRIPTION OF THE DRAWINGS

The accompanying drawings, which are incorporated in and constitute a part of this specification, illustrate some implementations described herein and, together with the description, explain these implementations. In the drawings:

FIG. 1 is a schematic illustration of a search query environment, according to an illustrative implementation;

FIG. 2 is a flowchart of a method for conducting search queries, according to an illustrative implementation;

FIG. 3 is an example screen shot of an electronic device displaying information to a user;

FIG. 4 is a schematic illustration of an electronic device used to conduct search queries, according to an illustrative implementation;

FIG. 5 is a schematic illustration of a search system used to conduct search queries, according to an illustrative implementation;

FIG. 6 is a flowchart of a method for conducting search queries, according to an illustrative implementation; and

FIG. 7 is a flowchart of a method for conducting search queries, according to an illustrative implementation.

### DETAILED DESCRIPTION

The following detailed description refers to the accompanying drawings. The same reference numbers in different drawings may identify the same or similar elements.

This document describes technology that may be used to provide a user with a diverse set of search results that are responsive to the user's voice input query. The search query techniques described herein (“technology”) can provide one or more of the following advantages. One advantage of the technology is that the technology provides the user with search results in an audible format so the user can listen to the results without having to look at a screen on the user's electronic device. Another advantage of the technology is that the technology provides the user with search results that include several components, each component containing information responsive to the search query. This allows the user to extract information from the search results in more than one way. One of the components of the information provided to the user includes an answer to the search query that is a set of text in a complete sentence form which minimizes the chances that the user will need to take any further action to satisfy the user's inquiry. The technology provides the added advantage of providing the user with the ability to acquire more information without running an additional search when the answer does not satisfy the user's need. Additional information is provided to the user in the search results in the form of, for example, a link to a web page where additional information is provided to the user when the user selects the link. This eliminates the need for the user to run a separate search to satisfy the user's inquiry.

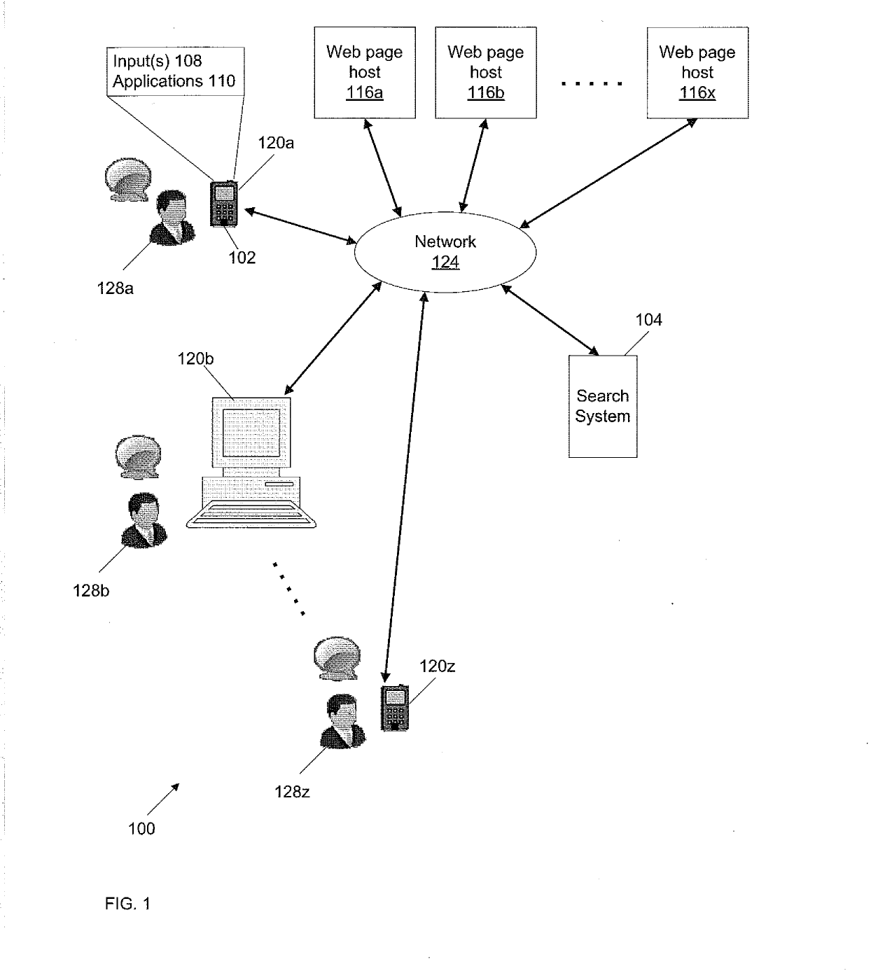

FIG. 1 is a schematic illustration of a search query environment 100, according to an illustrative implementation. The environment 100 includes a search system 104 for receiving search queries from a variety of users 128a, 128b, . . . 128z (generally 128) using a variety of electronic devices 120a, 120b, . . . 120z (generally 120 and also referred to as a client device or client devices). The search system 104 can include a server that includes a search engine. The users 128 initiate search queries by speaking their query into a microphone 102 of an electronic device 120. The electronic device 120 can be, for example, a mobile electronic device, laptop computer, personal digital assistant, a personal computer system, or other electronic communication device having a voice input interface for receiving voice input(s) 108 from a user.

The voice input query can be received by the electronic device 120 as an input to one of various applications 110 that can be executed on the electronic device 120, e.g., a web browser or an e-mail application. The spoken query received by the electronic device 120 is converted to a textual representation, and the search system 104 performs a search based on the textual representation. In some implementations the voice input query is transmitted to the search system 104, using the network 124, as an audio signal to be converted by the search system 104 to the textual representation. In some implementations, an application 110 running on the electronic device 120 converts the voice input query to the textual representation and then transmits the textual representation to the remote search system 104, using the network 124, for further processing. The network 124 can include one or more local area networks; a wide area network, e.g., the internet; a wireless network, e.g., a cellular network; or a combination of all or some of the above.

A processor, associated with the electronic device 120 or the search system 104, can use one or more language models to recognize the text in the spoken query. The processor can include a speech recognition application that identifies a language spoken by the user from the spoken query and converts the query into text by recognizing the speech in the input. In some implementations, the processor compares the spoken words to a database of stored words to identify what are the spoken words. In some implementations, the processor selects a best candidate, from a list of multiple possible candidates that one or more language models generate, as the textual representation to be used for subsequent processing.

After the search system 104 has the textual representation of the search query, the search system 104 searches for and returns relevant search result data that is responsive to the search terms of the textual representation of the spoken query. In this implementation, the search system 104 maintains an index of web pages that are compiled in an off-line mode. In the off-line mode, the search system 104 searches for web pages hosted by one or more web page hosts 116a, 116b, . . . 116x (generally 116). The search system 104 creates the index of the web page contents by, for example, using a web crawler. The web crawler finds and retrieves documents (e.g., web pages, onebox results generated from structured data, etc.) on the web. To retrieve a document from the web, the web crawler sends a request to, for example, a web page host 116 for a document, downloads the entire document, and then provides the document to an indexer. The indexer takes the text of the crawled document, extracts individual terms from the text and sorts those terms into a search index. The web crawler and indexer repeat this process for other documents available on the web. Each entry in the search index includes a term that is stored in association with a list of documents in which the term appears and the location within the document's text where the term appears. The search index, thus, permits rapid access to documents that contain terms that match search terms of a user supplied search query. Typical indexers create a single search index that contains terms extracted from all documents crawled on the web. The index is stored by the search system 104. In some implementations, a separate system or server creates the index and the search system 104 downloads an updated version of the index from that separate system or server on a periodic basis.

The goal of the search system 104 is to identify high quality, relevant results based on the search query using the search index. Typically, the search system 104 accomplishes this by matching the terms in the search query to terms contained in the search index, and retrieving a list of documents associated with each matching term in the search index. Documents that contain the user's search terms are considered hits and are returned to the user as the search results. The hits returned by the search system 104 may be ranked relative to each other by the search system 104 based on some measure of the quality and/or relevancy of the hits. A basic technique for sorting the search hits relies on the degree to which the search query matches the hits. For example, documents that contain every term of the search query or that contain multiple occurrences of the terms in the search query may be deemed more relevant than documents that contain less than every term of the search query or a single occurrence of a term in the search query and, therefore, may be more highly ranked by the search system.

The search system 104 then generates an electronic document that includes one or more search results. Typical formats used for the electronic document include the HyperText Markup Language (HTML) format or Extensible Markup Language (XML) format. The search system 104 then sends the electronic document to the user's electronic device 120 for execution at the electronic device 120. A web browser or application running on the user's electronic device 120 reads the HTML or XML document and renders the contents of the document into visible or audible web pages. For example, HTML is written in the form of HTML elements that include of tags enclosed in angle brackets within the web page content (like the following example, “<p>This is a sentence.</p>”). The start tag for a new paragraph is “<p>” and the stop tag is “</p>”. Textual and graphical content is included between the start and end tags. In this case, the textual content is “This is a sentence.” HTML tags are also available for including audible content in the HTML document to specify information that is provided to a user in response to a query. The browser does not display the HTML tags, but uses the tags to interpret the content of the page.

Users that initiate a search query using their voice may not be in a position to experience or otherwise access search result responses in a visual format using their electronic device 120. For example, it would be difficult and dangerous for a user to look at a display screen on the electronic device 120 while driving a vehicle. Therefore, it is desirable for the search results to include an audible component that does not require the user to look at a screen. However, users also often want to receive a more extensive set of results in response to a search query should the audible component not be sufficient for the users' purposes.

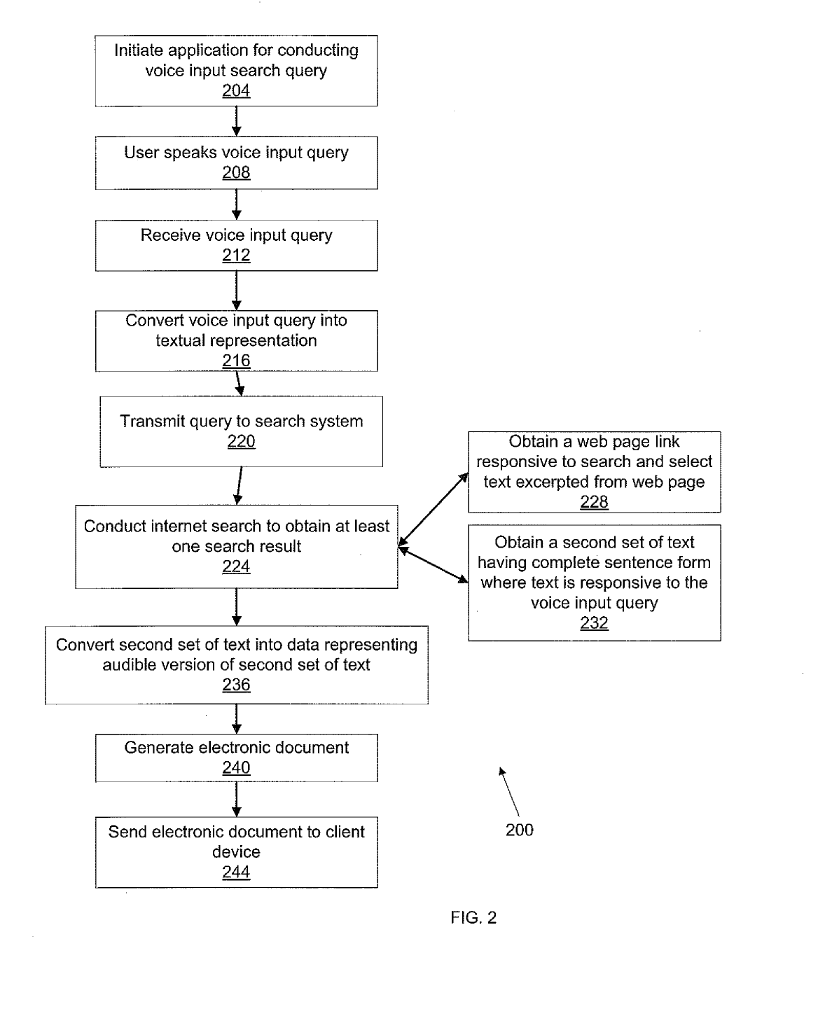

FIG. 2 is a flowchart 200 of a method for providing a comprehensive set of search results to a user that includes audible components as well as textual components, using the search query environment of FIG. 1. A user initiates (204) a search query application 110 on the user's electronic device 120. The search query application 110 can be, for example, a voice search function that receives spoken search queries using the microphone 102 of an internet enabled mobile phone device 120. The user then speaks a search query (208), having one or more search terms, into the microphone 102 of the electronic device 120. The search query application 110 receives the voice input query (212). A speech recognition application 110 running on the electronic device 120 converts (216) the voice input query into a textual representation, similarly as described previously herein. The textual representation of the voice input query is then transmitted (220) to the search system 104 using the network 124. In an alternative implementation, the voice input query is transmitted to the search system 104 before the voice input query is converted to a textual representation, and a speech recognition application operating on the search system 104 converts the voice input query.

When the search system 104 has the textual representation of the query, the search system 104 conducts a search (224). The search system 104 conducts the search using an available search index to obtain at least one relevant search result based on the items in the textual representation of the voice input query. In some implementations, a list containing multiple relevant search results is compiled. Each search result includes several components. In some implementations, the search result includes a link to a web page, a first set of text excerpted from the web page and a second set of text. The second set of text has a complete sentence form, and is responsive to the voice input query. The link and first set of text does not necessarily provide the user with a complete response to the query. The link and first set of text, while relevant to the search query, often requires that the user, for example, click on the link to access information that could be a complete response to the initial query.

The data included in the search result for each of the components is acquired from the contents of the search index. The different components of the search result data can be acquired from a single index or multiple indexes. For example, the link to the web page and the first set of text excerpted from the web page can be acquired from one index, and the second set of text can be acquired from another index. In some implementations, the second set of text included in the search result is expected to be delivered as a complete sentence that is responsive to the query; rather than a result that requires a user to click on a link to acquire the answer to its query. Answers taking the form of a complete sentence, that is a complete answer to the query, are termed “onebox” results. In some implementations, the types of information in a onebox result include dictionary definitions, news, stock quotes, weather, or biographical information. In some implementations, onebox results are generated in an offline process and stored by the search system 104 in a separate index. The onebox result can be acquired from a structured database maintained by the search system 104, where the result has a complete sentence form that can be acquired and/or generated from the database and is an answer responsive to the user query. In this implementation, the search system 104 obtains (232) a onebox result as the second set of text, and obtains (228) a web page link and text excerpted from the web page, as the first set of text. In some implementations, the first set of text may include a onebox result.

In some implementations, the search system 104 accesses a single search index to obtain the link to the web page, the first set of text excerpted from the web page, and the second set of text, where each component is accessed in the same index. In some implementations, the search system 104 selects a portion of the first set of text, which the search system 104 recognizes as being a complete response, to be used as the second set of text in the search result. In some implementations, each component of the web page that has text that can be spoken includes HTML markup language that designates what should be used for generating an audible response. There are various ways that the search system 104 can choose which set of text to use as the audible response. For example, the text at the top of the web page, or the text located in a designated location can be chosen. In some implementations, the second set of text may not be extracted from the results, but rather may be synthesized based on a number of variables (e.g., words from the original search query, contextual data such time and location, etc.).

The search system 104 then converts (236) the second set of text into data representing an audible version of the second set of text. The audible version of the second set of text can take on one of a variety of forms. In some implementations, the audible version of the second set of text is an audio file having one of a variety of available file formats, compressed or uncompressed, that permit the file to be stored on a computer system, e.g., a waveform audio file format (WAV), one of the various moving picture expert formats, such as MPEG, MP3, etc. The client device used to play the audio file would include a codec corresponding to the particular format of the audio file. The codec performs the encoding and decoding of the audio data in the audio file. The client devices typically have multiple codecs that support playing of audio files of different formats. In some implementations, an application or tool on a cloud-based server converts the second set of text into data representing an audible version of the second set of text. In some implementations, the application or tool on the cloud-based server converts the second set of text to an audio file. Cloud computing includes, generally speaking, a style of computing in which computing resources, e.g., application programs and file storage, are remotely provided over a network, e.g., over the internet. In some implementations, the resources are provided through a web browser.

In some implementations, the data representing the audible version of the second set of text is a hyperlink to a resource that can play an audio file containing the audible version of the second set of text. The resource can be, for example, a web server, a web page cloud server, or any other suitable server or service. In some implementations, the audible version of the text is a set of text that is marked to notify an application on the client device to convert the marked text to audio that is to be played for the user.

The search system 104 then generates (240) an electronic document, e.g., a HTML format document, which includes the link to the web page, the first set of text excerpted from the web page, and the data representing an audible version of the second set of text which is responsive to the voice input query. The following is an example of a portion of HTML code corresponding to data representing a hyperlink:
<audio src=“http://some.server.that.plays.audio/?text=the+text+to+speak” . . . >
   where the ellipsis “ . . . ” after the audio tag (“<audio”) is meant to include other attributes that an audio tag may have. For example, audio tags may have the “autoplay” attribute, which instructs a browser to execute and play the audio as soon as the page is loaded by a user's electronic device, as shown by the following:
<audio src=“http://some.server.that.plays.audio/?text=the+text+to+speak” autoplay>

The following is an example of a portion of HTML code corresponding to data representing an audio file:
<audiosrc=“data:audio/mpeg;base64,//NIxAAdMUYOAHjGcYaQFwKMWOR5EY0MUEE WgMDA3r4cWEJ9EDi . . . ” autoplay>
   where the ellipsis means the continuation of the encoded audio file, which can be encoded using base64-encoding.

The following is an example of a portion of HTML code corresponding to data representing an audible version of the second set of text, where the data is text that a browser will convert to audio, and the HTML code includes a predefined HTML attribute to accomplish that conversion:
<span PreDefAtt PreDefAtt-Txt=“the text to speak”> . . . </span>
   where “PreDefAtt” and “PreDefAtt-Txt” are the predefined attributes and the browser of the user's electronic device is configured to recognize that the contents of attribute PreDefAtt-Txt are to be converted to audio, and then played. The attributes can be predefined by a system administrator and used to mark text in the HTML document that is to be converted to audio. The client device would be configured to recognize the predefined HTML tags. In some implementations, predefined attributes can be created such that when the electronic document is sent to the user's client device, the electronic document includes the second set of text within the body of the first set of text. The second set of text is tagged with the predefined attributes and the browser recognizes the attributes causing the browser to convert the second set of text to audio and play it. In some implementations, the search system 104 adds the predefined attributes, e.g., “PreDefAtt” and “PreDefAtt-Txt”, to the second set of text to convert the complete response of the second set of text to an audible version.

The following is an example of a portion of HTML code corresponding to data representing a link to the web page, first set of text excerpted from the web page, and data representing the audible version of the second set of text, where the second set of text has a complete sentence form, and is responsive to the voice input query:
<span PreDefAtt PreDefAtt-Txt=“The empire state building is 381 meters tall”><ahref=“http://en.encyle/home/empire_state_building”>Encyclopedia—Empire State Building</a>—The Empire State Building is located in New York City . . . </span>
   where “The Empire State Building is located in New York City . . . ” is the first set of text, “http://en.encyle/home/empire_state_building” is the link to the web page, and “The empire state building is 381 meters tall” is the data representing the audible version of the second set of text.

The search system 104 then sends the electronic document (244) to the client device of the user for execution. In some implementations, the client device executes the electronic document and displays, on the device display, the link to the web page, the first set of text, the second set of text, and the client device also plays the audio file. In some implementations, the client device does not automatically play the audio file, but, rather, the client device displays an icon or piece of text corresponding to the data representing the audible version of the second set of text. The user can press a button or otherwise input a command to the electronic device, e.g., by clicking on the icon or text, to cause the device to play the audio.

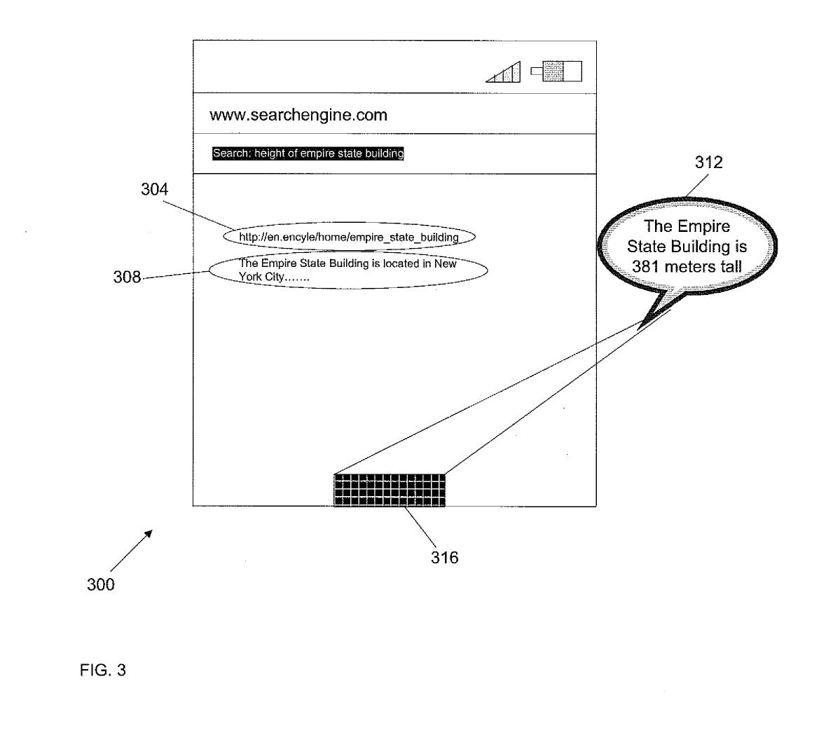

FIG. 3 is an example screen shot 300 of the electronic device 120a of FIG. 1 providing information to a user. The screen shot depicts a search result provided to a user in response to the voice input query [“height of empire state building”]. The electronic document sent by the search system 104 to the client electronic device 120a was executed by the electronic device 120a resulting in the electronic device 120a displaying a link to a website 304 and a first set of text 308 excerpted from the website. The audio file included a second set of text having a complete sentence form [“The Empire State Building is 381 meters tall”] that is responsive to the voice input query. The electronic device 120a automatically played the audio file 312 when audio file 312 was executed by the client device. A speaker 316 located on the electronic device 120a is used to play the audio file. Because the result provided to the user included an audible version of text and the link 304, the user is able to quickly and efficiently access additional information by, for example, tapping on the link 304 with the user's finger if the audible version proved inadequate or if the user wants to access additional information.

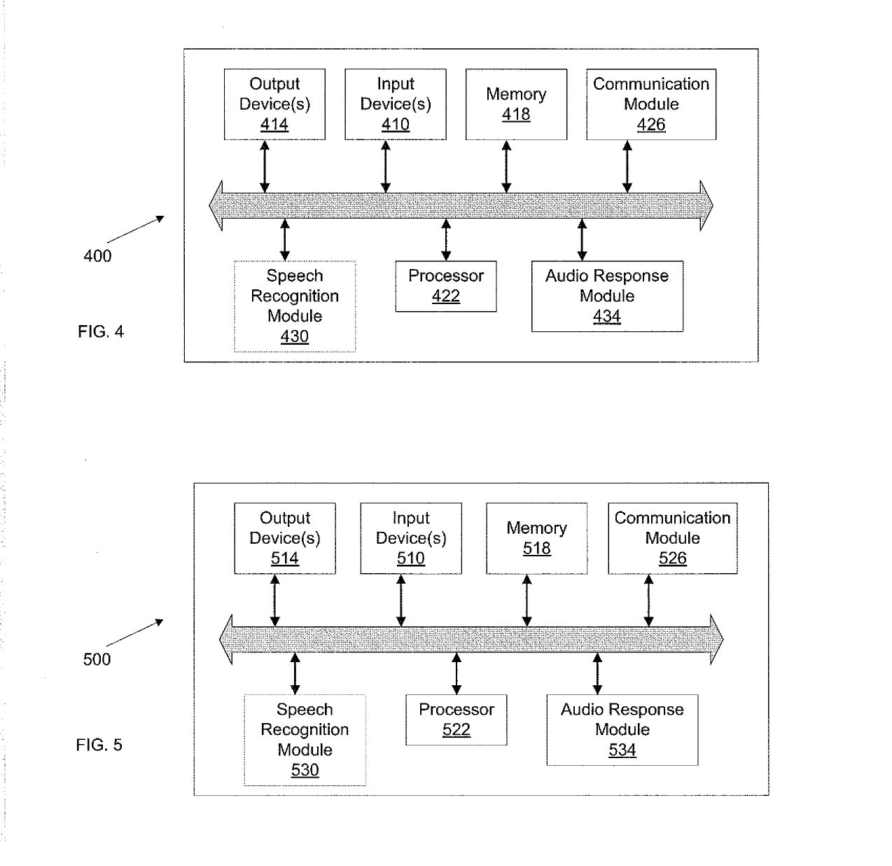

FIG. 4 is a schematic illustration of an electronic device 400, for example, one of the electronic devices 120 of FIG. 1 used by a user to conduct search queries. The electronic device 400 includes one or more input devices 410, one or more output devices 414, a processor 422, a memory 418, a communication module 426, an audio response module 434 and an optional speech recognition module 430. The modules and devices described herein can, for example, utilize the processor 422 to execute computer executable instructions and/or the modules and devices described herein can, for example, include their own processor to execute computer executable instructions. It should be understood the electronic device 400 can include, for example, other modules, devices, and/or processors known in the art and/or varieties of the described modules, devices, and/or processors.

The speech recognition module 438 is included in the electronic device 400 if the electronic device 400 is tasked with converting the user's spoken query to a textual representation of the spoken query. The speech recognition module 438 can use one or more language models to recognize the text in the spoken query. The speech recognition module 438 identifies a language spoken by the user from the spoken query and converts the query into text by recognizing the speech in the input. In some implementations, the speech recognition module 438 compares the spoken words to a database of stored words to identify what are the spoken words. In some implementations, the speech recognition module 438 selects a best candidate, from a list of multiple possible candidates that one or more language models generate, as the textual representation to be used for subsequent processing.

Communication module 426 is a telecommunication module that includes digital signal processing circuitry where necessary to provide the electronic device 120 with the ability to communication with other devices and systems using one or more networks under various modes or protocols, e.g., GSM, SMS, CDMA, or TDMA, among others. The audio response module 434 generates the audible version of the second set of text for audible presentation to a user. The audio response module 434 can generate the audible version of the second set of text based on the electronic document received from search system 104.

The input devices 410 receive information from a user and/or another computing system. The input devices 410 can include, for example, a keyboard, a scanner, a microphone, a stylus, a touch sensitive pad or display. The output devices 414 output information associated with the electronic device 400, e.g., information to a printer, information to a speaker, information to a display, for example, graphical representations of information. The processor 422 executes the operating system and/or any other computer executable instructions for the electronic device 400, e.g., executes applications. The memory 418 stores a variety of information/data, including configuration information, voice queries and results, calendar information, contact information, or e-mail messages. The memory 418 can include a one or more storage devices and/or the electronic device 400 can include a one or more storage devices. The memory 418 can include, for example, long-term storage, e.g., a hard drive, a tape storage device, or flash memory; short-term storage, e.g., a random access memory, or a graphics memory; and/or any other type of computer readable storage.

FIG. 5 is a schematic illustration of a search system 500, for example, the search system 104 of FIG. 1 used to conduct search queries and provide search results to a user. The search system 500 includes one or more optional input devices 510, one or more optional output devices 514, a processor 522, a memory 518, a communication module 526, an audio response module 534 and an optional speech recognition module 530. The modules and devices described herein can, for example, utilize the processor 522 to execute computer executable instructions and/or the modules and devices described herein can, for example, include their own processor to execute computer executable instructions. It should be understood the search system 500 can include, for example, other modules, devices, and/or processors known in the art and/or varieties of the described modules, devices, and/or processors.

The speech recognition module 538 is included in the search system 500 if the search system 500 is tasked with converting the user's spoken query to a textual representation of the spoken query. The speech recognition module 538 can use one or more language models to recognize the text in the spoken query. Communication module 526 is a telecommunication module that includes digital signal processing circuitry where necessary to provide the search system 500 with the ability to communication with other devices and systems using one or more networks under various modes or protocols, e.g., GSM, SMS, CDMA, or TDMA, among others. The audio response module 534 provides audible response, e.g., receives search results and converts the second set of text into data representing an audible version of the second set of text.

The input devices 510 receive information from a user and/or another computing system. The input devices 510 can include, for example, a keyboard, a scanner, a microphone, a stylus, a touch sensitive pad or display. The output devices 514 output information associated with the search system 500, e.g., information to a printer, information to a speaker, information to a display, for example, graphical representations of information. The processor 522 executes the operating system and/or any other computer executable instructions for the search system 500, e.g., executes applications. The memory 518 stores a variety of information/data, including configuration information, voice queries and results, calendar information, contact information, or e-mail messages. The memory 518 can include a one or more storage devices and/or the search system 500 can include a one or more storage devices. The memory 518 can include, for example, long-term storage, e.g., a hard drive, a tape storage device, or flash memory; short-term storage, e.g., a random access memory, or a graphics memory; and/or any other type of computer readable storage.

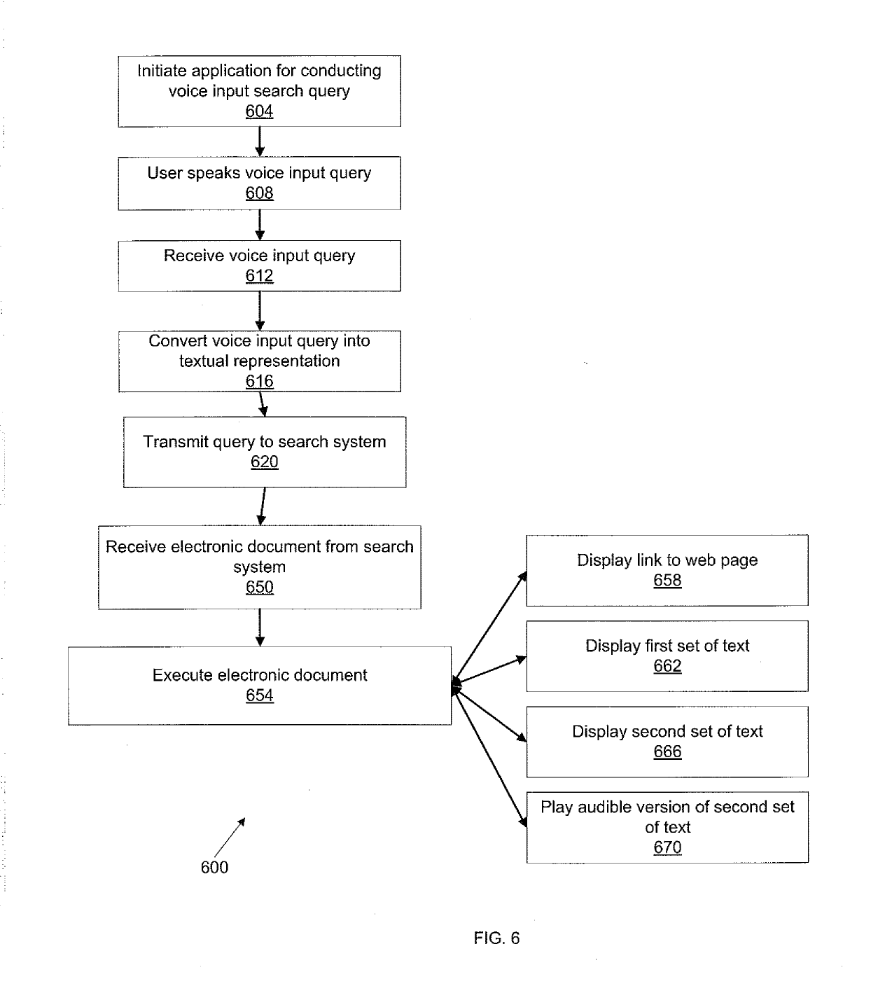

FIG. 6 is a flowchart 600 of a method for providing search results to a user that includes audible components as well as textual components, using the search query environment of FIG. 1. A user initiates (604) a search query application 110 on the user's electronic device 120. The search query application 110 can be, for example, a voice search function that receives spoken search queries using the microphone 102 of an internet enabled mobile phone device 120. The user then speaks a search query (608), having one or more search terms, into the microphone 102 of the electronic device 120. The search query application 110 receives the voice input query (612). A speech recognition application 110 running on the electronic device 120 converts (616) the voice input query into a textual representation, similarly as described previously herein. The textual representation of the voice input query is then transmitted (620) to the search system 104 using the network 124.

The electronic device 120 receives an electronic document (650) from the search system 104. The electronic document includes one or more search results that are responsive to the voice input query. The electronic document can be, for example, a HTML format document, which includes the link to a web page for a search result, a first set of text excerpted from the web page, and data representing an audible version of a second set of text. The second set of text has a complete sentence form, and is responsive to the voice input query. The client device executes the electronic document (654). In some implementations, when the electronic document is executed, the client device displays the link to the web page (658), displays the first set of text (662), displays the second set of text (666), and/or plays an audible version of the second set of text (670). In some implementations, the client device does not automatically play the audio file, but, rather, the client device displays an icon or piece of text corresponding to the data representing the audible version of the second set of text. The user presses a button or otherwise inputs a command to the electronic device, e.g., by clicking on the icon or text, to cause the device to play the audio.

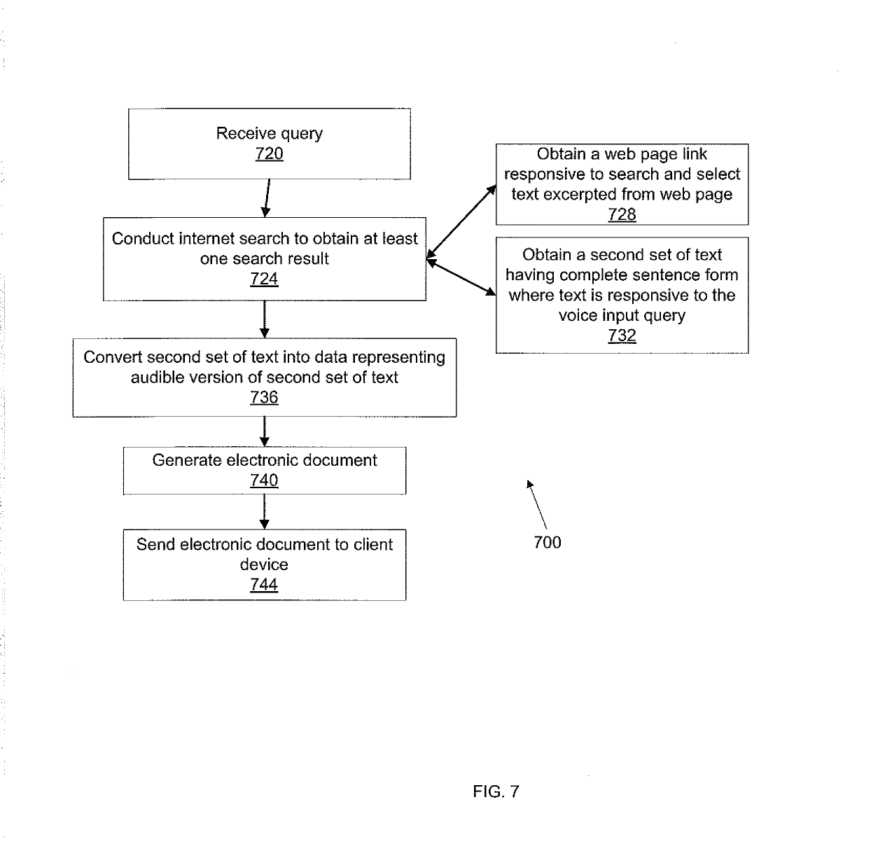

FIG. 7 is a flowchart 700 of a method for providing search results to a user that includes audible components as well as textual components, using the search query environment of FIG. 1. The search system 104 receives a textual representation of a voice input query (720). In an alternative implementation, the voice input query is transmitted to the search system 104 before the voice input query is converted to a textual representation, and a speech recognition application operating on the search system 104 converts the voice input query to a textual representation of the voice input query.

When the search system 104 has the textual representation of the query, the search system 104 conducts a search (724). The search system 104 conducts the search using, for example, an available search index to obtain at least one relevant search result based on the items in the textual representation of the voice input query. Each search result includes several components. In some implementations, the search result includes a link to a web page, a first set of text excerpted from the web page and a second set of text. The second set of text has a complete sentence form, and is responsive to the voice input query. The link and first set of text does not necessarily provide the user with a complete response to the query. The link and first set of text, while relevant to the search query, often requires that the user, for example, click on the link to access information that could be a complete response to the initial query. In some implementations, the search system obtains (732) a onebox result as the second set of text, and obtains (728) a web page link and text excerpted from the web page, as the first set of text.

The search system 104 then converts (736) the second set of text into data representing an audible version of the second set of text. The audible version of the second set of text can take on one of a variety of forms. In some implementations, the audible version of the second set of text is an audio file. The search system 104 then generates (740) an electronic document, e.g., a HTML format document, which includes the link to the web page, the first set of text excerpted from the web page, and the data representing an audible version of the second set of text which is responsive to the voice input query. The search system then sends (744) the electronic document to the client device for audible presentation of the audible version of the second set of text.

Method steps can be performed by one or more programmable processors executing a computer program to perform functions of the disclosure by operating on input data and generating output. Method steps can also be performed by, and an apparatus can be implemented as, special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data. Magnetic, magneto-optical disks, or optical disks are examples of such storage devices.

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

The system can include clients and servers, e.g., web servers and cloud servers. A client and a server can be remote from each other and may interact through a communication network. The relationship of client and server arises by virtue of computer programs running on the respective computers and having a client-server relationship to each other. In some implementations, the servers are cloud-based servers in which computing resources, e.g., application programs and file storage, are remotely provided over a network.

A computing device can include, for example, a computer, a computer with a browser device, a telephone, an IP phone, a mobile device, and/or other communication devices. Mobile devices can include a cellular phone, personal digital assistant (PDA) device, laptop computer, or electronic mail device. The browser device includes, for example, a computer with a world wide web browser. The mobile computing device includes, for example, a smart phone.

Comprise, include, and/or plural forms of each are open ended and include the listed parts and can include additional parts that are not listed. And/or is open ended and includes one or more of the listed parts and combinations of the listed parts.

Various implementations of the systems and techniques described herein can be realized in digital electronic circuitry, integrated circuitry, specially designed application specific integrated circuits, computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications, or code, include machine instructions for a programmable processor, and can be implemented in a high-level procedural and/or object-oriented programming language, and/or in assembly/machine language. As used herein, the terms “machine-readable medium” and “computer-readable medium” refer to any apparatus and/or device, e.g., magnetic discs, optical disks, memory, Programmable Logic Devices, used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device, e.g., a cathode ray tube or liquid crystal display monitor, for displaying information to the user and a keyboard and a pointing device, e.g., a mouse or a trackball, by which the user can provide input to the computer. Other kinds of devices can be used to provide for interaction with a user as well. For example, feedback provided to the user can be any form of sensory feedback, e.g., visual feedback, auditory feedback, or tactile feedback. Also, input from the user can be received in any form, including acoustic, speech, or tactile input.

The systems and techniques described herein can be implemented in a computing system that includes a back end component, e.g., as a data server, or that includes a middleware component, e.g., an application server, or that includes a front end component, e.g., a client computer having a graphical user interface or a Web browser through which a user can interact with some implementations of the systems and techniques described here, or any combination of such back end, middleware, or front end components. The components of the system can be interconnected by any form or medium of digital data communication, e.g., a communication network. Examples of communication networks include a LAN, a WAN, and the Internet.

The foregoing description provides illustration and description, but is not intended to be exhaustive or to limit the implementations to the precise form disclosed. Modifications and variations are possible in light of the above disclosure or may be acquired from practice of the implementations.

As used herein, the term component is intended to be broadly interpreted to refer to hardware or a combination of hardware and software, such as software executed by a processor.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the articles “a” and “an” are intended to include one or more items and may be used interchangeably with “one or more.” Where only one item is intended, the term “one” or similar language is used. Further, the phrase “based on” is intended to mean “based, at least in part, on” unless explicitly stated otherwise.

1. A method comprising:
determining, by one or more computer devices, at least one search result that is responsive to a textual representation of a voice query,
the at least one search result including:
a reference to a first document related to the voice query,
a first set of text from the first document, and
a second set of text that is responsive to the voice query;
converting, by the one or more computer devices, the second set of text into information corresponding to an audible version of the second set of text;
generating, by the one or more computer devices, a second document that includes the reference to the first document, the first set of text, the second set of text, and the information corresponding to the audible version of the second set of text; and
providing, by the one or more computer devices, the second document to a client device;
wherein the second set of text includes contextual data generated by the client device.

2. The method of claim 1, further comprising:
receiving the voice query from the client device; and
converting the voice query into the textual representation of the voice query.

3. The method of claim 1, further comprising: receiving the textual representation of the voice query from the client device.

4. The method of claim 1, wherein the audible version of the second set of text comprises an executable file.

5. The method of claim 1, where the second set of text is selected from text located in a designated location of the first document.

6. (canceled)

7. A device comprising:
one or more processors to:
determine at least one search result that is responsive to a textual representation of a voice query,
the at least one search result including:
a reference to a first document related to the voice query,
a first set of text from a content of the first document, and
a second set of text that is responsive to the voice query;
convert the second set of text into information corresponding to an audible version of the second set of text;
generate a second document that includes the reference to the first document, the first set of text, the second set of text, and the information corresponding to the audible version of the second set of text; and
provide the second document to a client device for presentation on a display;
wherein the second set of text includes contextual data generated by the client device.

8. The device of claim 7, where the one or more processors are further to:
receive the voice query from the client device,
convert the voice query into the textual representation of the voice query, and
perform a search, based on the textual representation of the voice query, to generate the at least one search result.

9. The device of claim 7, where the one or more processors are further to: receive the textual representation of the voice query from the client device, and
perform a search, based on the textual representation of the voice query, to generate the at least one search result.

10. The device of claim 7, wherein the audible version of the second set of text comprises an executable file.

11. The device of claim 7, where the second set of text is selected from text located in a designated location of the first document.

12. (canceled)

13. A method comprising:
receiving, by a client device, a voice query;
converting, by the client device, the voice query into a textual representation of the voice query;
providing, by the client device, the textual representation of the voice query to a search system;
receiving, by the client device and from the search system, at least one search result that is responsive to the textual representation of the voice query,
the at least one search result including:
a reference to a document related to the voice query,
a set of text that is responsive to the voice query, the set of text being a complete sentence response to the voice query that includes contextual data generated by the client device, and
information corresponding to an audible version of the set of text;
providing, by the client device and for display, the reference to the document and the set of text; and
executing the audible version of the set of text based on the selection.

14-16. (canceled)

17. A device comprising:
one or more processors to:
receive a voice query;
transform the voice query into a textual representation of the voice query;
provide the textual representation of the voice query to a search system;
receive, from the search system, at least one search result that is responsive to the textual representation of the voice query,
the at least one search result including:
a reference to a document related to the voice query,
a first set of text from a portion of the document,
a second set of text that is responsive to the voice query, the second set of text being a complete sentence response to the voice query that includes contextual data generated by the device, and
information corresponding to an audible version of the second set of text;
provide, for display, the reference to the document, the first set of text, and the second set of text; and
execute the audible version of the second set of text.

18-19. (canceled)

20. The device of claim 17, where the portion of the first set of text is selected as the second set of text, and is selected from text located in a designated location of the document.

21. The method of claim 1, wherein the second set of text is selected from a portion of the first set of text recognized as being a complete sentence response to the voice query.

22. The method of claim 1, wherein the input device comprises a microphone.

23. The method of claim 1, wherein the input device comprises a touch sensitive display.

24. The method of claim 13, wherein the input device comprises a microphone.

25. The method of claim 13, wherein the input device comprises a touch sensitive display.

26. The method of claim 1, wherein the contextual data includes a geographic location of the client device.

27. The method of claim 1, wherein the information corresponding to the audible version of the second set of text comprises markup language code that triggers an application executing on the client device to convert text representing the audible version of the second set of text to audio output.
